(19) United States
(12) Patent Application Publication
(10) Pub. No.: US 2020/0122042 A1
(43) Pub. Date: Apr. 23, 2020

(54) Methods and Systems for Enabling a User to Predict a Series of Real-Time Events

(71) Applicants: Erik Bargh Guffrey, Cary, NC (US); Grant Culver Fowler, Durham, NC (US); John Wesley Jourdan, Durham, NC (US); Austin Allan Cline, Apex, NC (US)

(72) Inventors: Erik Bargh Guffrey, Cary, NC (US); Grant Culver Fowler, Durham, NC (US); John Wesley Jourdan, Durham, NC (US); Austin Allan Cline, Apex, NC (US)

(21) Appl. No.: 16/654,833

(22) Filed: Oct. 16, 2019

Related U.S. Application Data
(60) Provisional application No. 62/746,693, filed on Oct. 17, 2018.

(51) Int. Cl. A63F 13/80; G06N 5/04; A63F 13/332; A63F 13/335

(52) U.S. Cl. CPC A63F 13/80; A63F 13/335; A63F 13/332; G06N 5/04

(57) ABSTRACT

Methods and systems for enabling a user to predict a series of real-time events that occur in a sequential order. Each of the events occurs within a time window and has an outcome. A user interface is generated and output to a display for presentation to a user. The user interface may include aspects of the real-time events and facilitates a user to predict an outcome. A user prediction is received from the user during the time window that runs prior to the real-time event. Once the real-time event occurs, an actual outcome of the event is determined. An accuracy is determined between the user prediction and the actual outcome. The user can be notified about the accuracy of their prediction.

### CROSS-REFERENCE TO RELATED APPLICATIONS

The present application claims the benefit of U.S. Application No. 62/746,693 filed on Oct. 17, 2018. This application is hereby incorporated by reference in its entirety.

### BACKGROUND

There are many happenings that include repeated occurrences of an event. Examples include but are not limited to plays during a sporting event (e.g., pitches during a baseball game, plays during a football game, shots on goal in a hockey game), specific aspects of the daily weather (e.g., high temperature, rainfall amount), and daily events in the stock market. These events have objective outcomes.

### SUMMARY

One aspect is directed to a method, implemented by an electronic device, that comprises: generating a user interface configured to enable a user to predict, for a plurality of sequentially-occurring real-time events during a respective time window, an outcome of the real-time event from a plurality of available outcomes; receiving via the user interface, during each of the time windows and prior to the corresponding real-time event, a user prediction indicating at least one of the outcomes; responsive to each of the real-time events occurring, determining an actual outcome of the real-time event; and notifying the user of an accuracy of the corresponding user prediction based on the actual outcome.

In another aspect, generating the user interface comprises outputting the user interface on a display device.

In another aspect, generating the user interface comprises sending a definition of the user interface to a remote computing device for display on a display device.

In another aspect, the method comprises generating the user interface in response to receiving a request from the user to predict the plurality of real-time events.

In another aspect, determining the actual outcome of the real-time event comprises receiving the actual outcome from the third party prior to the occurrence of the next one of the real-time events.

In another aspect, the method comprises calculating a numerical value score for the real-time event based on a difference between the user prediction and the actual outcome of the real-time event after each occurrence of one of the plurality of real-time events.

In another aspect, the electronic device is a server that communicates with a computing device via a packet data network.

In another aspect, the method is implemented at a user computing device.

In another aspect, the series of real-time events comprises plays in a game.

In another aspect, the method comprises displaying scores of one or more additional users that are also predicting the series of real time events.

One aspect is directed to a method implemented by a first computing device that communicates with a second computing device via a packet data network of enabling a user to predict a series of real-time events. The method comprises receiving a request from the second computing device to predict a plurality of sequentially-occurring real-time events that occur over a predetermined period and that have a plurality of available outcomes. Prior to each real-time event, the method includes: transmitting via the packet data network to the second computing device a user interface configured to enable a user to predict the real-time event by selecting one of the plurality of available outcomes; and receiving the selected outcome from the second computing device via the packet data network. The method includes after each real-time event and prior to a subsequent one of the plurality of real-time events: determining an actual outcome of the real-time event; calculating a numerical value score for the real-time event based on a difference between the selected outcome and the actual outcome; and calculating a score for the user.

In another aspect, determining the actual outcome of the real-time event comprises receiving the actual outcome from a remote third party through the packet data network.

In another aspect, the method comprises receiving the actual outcome from the third party prior to the occurrence of the next one of the real-time events.

In another aspect, the method comprises the user interface having a discrete number of the available outcomes.

In another aspect, the method comprises: receiving via the packet data network selected outcomes of the real-time event from a plurality of additional users; and after the real-time event and prior to a subsequent one of the real-time events, calculating a numerical value score for the real-time event for each of the plurality of additional users based on a difference between the selected outcome of the event and the actual outcome of the event.

In another aspect, the method comprises transmitting via the packet data network to the second computing device a current position of the user relative to the plurality of additional users based on the numerical value scores.

In another aspect, each of the real-time events comprises a different play during a game.

One aspect is directed to a computer program product stored in a non-transitory computer readable medium for controlling a computing device with the computer program product comprising software instructions that, when run on the computing device, cause the computing device to: generate a user interface configured to enable a user to predict, for a plurality of sequentially-occurring real-time events during a respective time window, an outcome of the real-time event from a plurality of available outcomes; receive, during each of the time windows and prior to the corresponding real-time event, a user prediction of at least one of the outcomes; determine an actual outcome of the real-time event; and notify the user of an accuracy of the corresponding user prediction based on the actual outcome.

One aspect is directed to a method, implemented by an electronic device, of determining user prediction accuracy provided by a user under real-time constraints with the method comprising: generating a user interface configured to accept, from a user and for each of a series of upcoming real-time events occurring after respective time windows, a prediction selected by the user from a plurality of potential outcomes that are the same for each of the real-time events in the series; responsive to receiving the prediction for a real-time event in the series during the corresponding time window, obtaining an accuracy of the prediction calculated based on the prediction and an actual outcome of the real-time event, and notifying the user of the accuracy.

In another aspect, the method is implemented at a server.

In another aspect, the method is implemented at a user device.

In another aspect, the method is implemented at both a server and a user device.

One aspect is directed to a method, implemented by an electronic device, of enabling a user to predict a series of real-time events. The method comprises: generating a user display that facilitates a user to predict an outcome of each of a series of real-time events that occur in a sequential order with each of the real-time events occurring within a time window and having a plurality of outcomes; during each of the time windows and prior to an occurrence of the real-time event, receiving a user prediction of one of the outcomes; at the end of each of the time windows, receiving an actual outcome from a third party; and at the end of each of the time windows, notifying the user of an accuracy of the user prediction.

One aspect is directed to a method, implemented by an electronic device, of enabling a user to predict a series of real-time events with the method comprising: receiving a request from a user; in response to receiving the request, generating a user display for the user to individually predict an outcome of each of a series of real-time events that occur in a sequential order with each of the real-time events occurring within a time window and having a plurality of outcomes; during each time window and prior to the occurrence of the real-time event in the time window, receiving a user prediction of one of the outcomes; at the end of each of each of the real-time events and prior to the occurrence of the next one of the real-time events, receiving an actual outcome of the real-time event and notifying the user of an accuracy of the user prediction.

One aspect is directed to a method of conducting a real-time game with the method being implemented by a server that communicates with computing devices via a packet data network. The method comprises: determining a plurality of users participating in a contest with the contest comprising a plurality of discrete, repeatable plays that occur over a predetermined period; prior to each play of the contest: transmitting via the packet data network to the respective computing devices of the users an electronic selection interface comprising an input display to select outcomes of the play; and receiving from the respective computing devices of the users via the packet data network, an expected outcome of the play. The method comprises after each play of the contest and prior to a subsequent play of the contest: receiving from a remote third party an actual outcome of the play; for each user, calculating a numerical value score for the play based on a difference between the expected outcome of the play and the actual outcome of the play; calculating an aggregate score for each user; and at the end of the contest, determining the user with the highest aggregate score.

One aspect is directed to a method of conducting a real-time game with the method being implemented by a server that communicates with a computing device via a packet data network. The method comprises: receiving a request from a computing device of a user to participate in a contest with the contest comprising a plurality of discrete, repeatable plays that occur over a predetermined period. The method comprises that prior to each play of the contest: transmitting via the packet data network to the computing device of the user an electronic selection interface comprising an input display to select outcomes of the play; receiving from the computing device of the user via the packet data network, an expected outcome of the play. The method comprise that after each play of the contest and prior to a subsequent play of the contest: receiving from a remote third party an actual outcome of the play; calculating a numerical value score for the play based on a difference between the expected outcome of the play and the actual outcome of the play; and calculating an aggregate score for the user.

One aspect is directed to a user device that determines user prediction accuracy provided by a user under real-time constraints with the user device comprising: one or more circuits configured to: generate a user interface configured to accept, from a user and for each of a series of upcoming real-time events occurring after respective time windows, a prediction selected by the user from a plurality of potential outcomes that are the same for each of the real-time events in the series; and responsive to receiving the prediction for a real-time event in the series during the corresponding time window, obtain an accuracy of the prediction calculated based on the prediction and an actual outcome of the real-time event, and notifying the user of the accuracy.

One aspect is directed to a server that determines user prediction accuracy provided by a user under real-time constraints. The server comprising: one or more circuits configured to: generate a user interface configured to accept, from a user and for each of a series of upcoming real-time events occurring after respective time windows, a prediction selected by the user from a plurality of potential outcomes that are the same for each of the real-time events in the series; responsive to receiving the prediction for a real-time event in the series during the corresponding time window, obtain an accuracy of the prediction calculated based on the prediction and an actual outcome of the real-time event, and notifying the user of the accuracy.

One aspect is directed to a computer program product stored in a non-transitory computer readable medium for controlling a server with the computer program product comprising software instructions that, when run on the server, cause the server to: generate a user interface configured to accept, from a user and for each of a series of upcoming real-time events occurring after respective time windows, a prediction selected by the user from a plurality of potential outcomes that are the same for each of the real-time events in the series; and responsive to receiving the prediction for a real-time event in the series during the corresponding time window, obtain an accuracy of the prediction calculated based on the prediction and an actual outcome of the real-time event, and notifying the user of the accuracy.

One aspect is directed to a computer program product stored in a non-transitory computer readable medium for controlling a user device, the computer program product comprising software instructions that, when run on the user device, cause the user device to: generate a user interface configured to accept, from a user and for each of a series of upcoming real-time events occurring after respective time windows, a prediction selected by the user from a plurality of potential outcomes that are the same for each of the real-time events in the series; and responsive to receiving the prediction for a real-time event in the series during the corresponding time window, obtain an accuracy of the prediction calculated based on the prediction and an actual outcome of the real-time event, and notifying the user of the accuracy.

The various aspects of the various embodiments may be used alone or in any combination, as is desired.

### BRIEF DESCRIPTION OF THE DRAWINGS

FIG. 1 is a schematic diagram of a series of real-time events, predictions, and actual outcomes that occur during a time period.

FIG. 2 is a schematic diagram of a user device.

FIG. 3 is a schematic diagram of a computing system that includes computing devices that communicate over a wireless communication network.

FIG. 3A is a schematic diagram of a server.

FIGS. 4-11 are front views of user interfaces that display aspects of enabling a user to predict sequentially-occurring real-time events.

FIG. 12 is a flowchart diagram of a method of enabling a user to predict sequentially-occurring real-time events.

### DETAILED DESCRIPTION

The present application is directed to methods and systems for enabling a user to predict a series of real-time events that occur in a sequential order. Each of the events occurs within a time window and has an outcome. A user interface is generated and output to a display for presentation to a user. The user interface can include aspects of the real-time events and facilitates a user to predict an outcome. A user prediction is received from the user during the time window that runs prior to the real-time event. Once the real-time event occurs, an actual outcome of the event is determined. An accuracy is determined between the user prediction and the actual outcome. The user can be notified about the accuracy of their prediction.

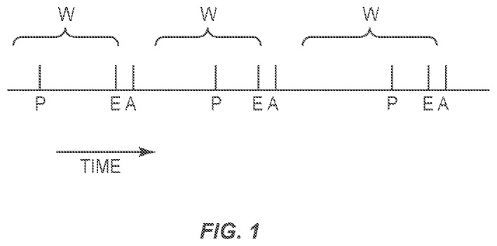

FIG. 1 schematically illustrates a series of real-time events E that occur sequentially over a period of time. Each of the real-time events has a determinable outcome. A time window W occurs prior to each event E and terminates at the occurrence of the event. Within each time window W, the user is able to view the user display and make a prediction P. The prediction P can occur at various times within the time window W depending upon the speed of the user. After the real-time event E, an actual outcome A is received. The accuracy of the user is then determined based on the difference between the user prediction P and the actual outcome A. The user is then notified of their accuracy.

The series of events can include various actions. Examples include but are not limited to various actions during sporting events, the color of cars passing on a road, and the temperature each day over a week or month. Each of the events has a discernable outcome and the events happen sequentially over time. Using the examples, events can include a baseball game with pitches during an inning, a football game with running plays and passing plays, the color of each car that passes a house during a period of time, and the high temperature for each day over a week. The user interface allows the user to make their prediction of the outcome of the event. After the event, an actual outcome of is determined. The accuracy of the user prediction can be determined and the user can be notified accordingly.

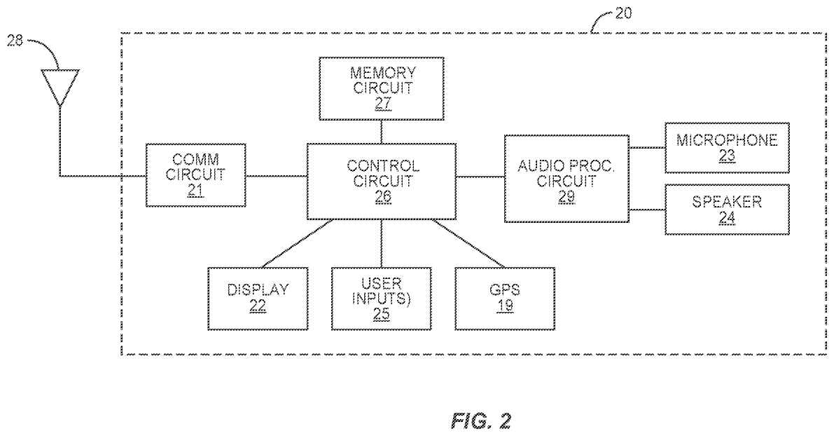

The user interface can be accessible by the user with an electronic device 20. FIG. 2 illustrates a block diagram of an electronic device 20 that includes a control circuit 26 that controls the overall functioning of the device 20. The control circuit 26 can include one or more microprocessors, microcontrollers, Application Specific Integrated Circuits (ASICs), or other programmable devices. The control circuit 26 can be configured to execute program code stored within the device 20 or accessible by the device 20, to control the various components and their functions. For example, the program code can be stored in memory circuit 27, or can be downloaded from a remote source (e.g., a server).

Memory circuit 27 can include one or several types of non-transitory memory, including, for example, read-only memory, flash memory, magnetic or optical storage devices, or the like. In some embodiments, one or more physical memory units may be shared by the various components. Other embodiments may have physically separate memories for one or more of the different components.

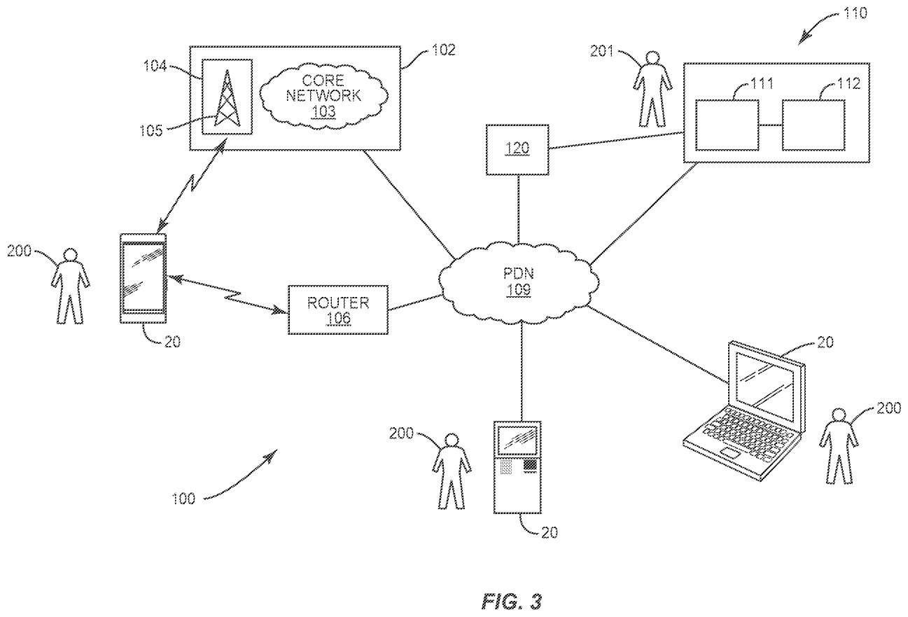

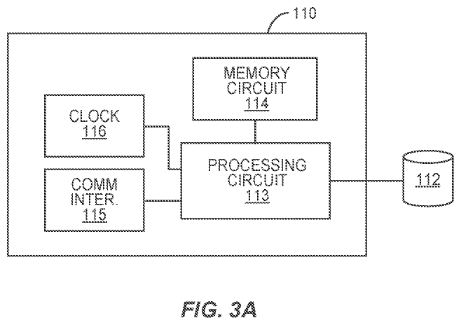

A communications circuit 21 provides wireless access to a packet data network (PDN) to facilitate communication between the device 20 and a server 110 (see FIG. 3). The communications circuit 21 can include a radio frequency transmitter and receiver for transmitting and receiving signals through an antenna 28. The communications circuit 21 can be further configured to send and receive information through various formats, such as but not limited to SMS text messages and files.

The display 22 provides viewable information such as the user interface. The display 22 can include various formats, such as but not limited to a liquid crystal display. User inputs 25 can include various input devices, such as but not limited to a keyboard, touch screen, track ball, toggle switch, and joystick. The user inputs 25 provide for the user to enter various commands and make menu selections for menus presented on the display 22. A global positioning system (GPS) component 19 can be configured to receive coordinate information from various sources (e.g., satellites, base stations) to determine a geographic position of the device 20 and the corresponding user.

The device 20 can further includes a microphone 23, speaker 24, and an audio processing circuit 29. The audio processing circuit 29 is configured to provide audio processing functionality for processing voice data for communications through the speaker 23 and microphone 24. FIG. 2 includes separate communication and audio processing circuits 21, 29. One or both of the functionality performed by these circuits 21, 29 can be included within the control circuit 26.

The various user devices 20 are used by users 200 for communications over a wireless communication network 100 as illustrated in FIG. 3. The wireless communication network 100 includes a server 110 that is accessed by users 200. Each user 200 has an electronic device 20 to access the server 110. The electronic devices 20 can include a cellular interface that enables communication with a mobile communication network 102 (e.g., a WCDMA, LTE, or WMAX network). The mobile communication network (MCN) 102 includes a core network 103 and a radio access network (RAN) 104 including one or more base stations 105. The MCN 102 can be a conventional cellular network operating according to any communication standards now known or later developed. For example, the MCN 102 can include a Wideband Code Division Multiple Access (WCDMA) network, a Long Term Evolution (LTE) network, or WiMAX network. The MCN 102 is further configured to access the PDN 109. The PDN 109 can include a public network such as the Internet, or a private network.

As further illustrated in FIG. 3, the electronic device 20 can also be able to communicate with a wireless access point 106 to access the PDN 109 and communicate with other computing devices. In one or more embodiments, the electronic device 20 includes a Wireless Local Area Network (WLAN) interface that operates according to the 802.11 family of standards, which is commonly known as a WiFi interface. The electronic device 20 can further include a personal area network (PAN) interface, such as a BLUETOOTH, RFID, and ZIGBEE interface.

The electronic device 20 can also be connected to a nearby device (not shown) through a wired interface, such as a RS 232, USB or FIREWARE interface. Such a device would be configured to access the PDN 109.

The electronic device 20 is configured to communicate through the PDN 109 to the server 110. The server 110 can be configured to provide a web interface 111 as illustrated in FIG. 3. The system is configured for accessing information through the server 110 using a browser-based interface or an applications program interface (API). The browser-based interface can include a website through which the contents of a database 112 can be accessible. Although the website may be hosted by the server 110, it can also be hosted at another location accessible through the PDN 109. The different users 200 can log into and access the pertinent information at various stages throughout the process. Alternatively, the different users 200 can access the sever 110 using one or more Application Programming Interfaces (APIs) through a desktop or mobile client, for example.

FIG. 3A illustrates the server 110 that includes one or more processing circuits (illustrated as processing circuit 113) that can include one or more microprocessors, microcontrollers, Application Specific Integrated Circuits (ASICs), or the like, configured with appropriate software and/or firmware. A computer readable storage medium (shown as memory circuit 114) stores data and computer readable program code that configures the processing circuit 113 to implement the techniques described above. Memory circuit 114 is a non-transitory computer readable medium, and can include various memory devices such as random access memory, read-only memory, and flash memory. A communication interface 115 connects the server 110 to the PDN 109, and can be configured to communicate with the PDN 109 according to one or more 802.11 standards. The communication interface 115 can support a wired connection (e.g., Ethernet), a wireless connection, or both. The database 112 is stored in a non-transitory computer readable storage medium (e.g., an electronic, magnetic, optical, electromagnetic, or semiconductor system-based storage device). The database 112 can be local or remote relative to the electronic devices. A clock 116 can be associated with the processing circuit 113 that measures the various timing requirements for specific events. The clock 116 can be incorporated with the processing circuit 113, or may be a separate component independent from the processing circuit 113. The clock 113 can be configured to measure the specific time during each an event.

As illustrated in FIG. 3, the server 110 can be configured to provide a web interface 111 to support the methods. The web interface 111 can support a website through which the contents of the database 112 are accessible. In one or more embodiments the web interface 111 provides browser-based access to the contents of the database 112. The different entities 200 can login to the browser-based interface and access the information. Alternatively, the different entities 200 can access a game using one or more Application Programming Interfaces (APIs) through a desktop or mobile client, for example. Also, in one or more embodiments the web interface 111 supports access to the database 112 using web services in addition to, or as an alternative to, the browser-based interface described above.

The different entities 200 can access the information at the server 110 through a variety of devices 20. The devices 20 can include laptop computers, personal computers, personal digital assistants, mobile computing/communication, tablet devices, and various other-like computing devices. The devices 20 can also include a body-worn device such as a watch or pendant configured to provide access. In one embodiment, one or more of the users 200 can use his or her respective device 20 to access the server 110 through a separate portal. Each user's portal can include a secure interface through which the entity may access the information that is assigned to them.

In one or more embodiments, the server 110 can be configured for browser-based accessibility. The browser-based interface can support well-known browsers such as Internet Explorer and Mozilla Firefox, Safari, Chrome. Alternatively, or in conjunction with the browser-based interface, the server 110 can provide access to database 112 to requesting APIs over the PDN 109.

The various users 200 are enrolled by registering with the server 110 (e.g., via the browser-based interface or with the administrator 201 (e.g., in a non-electronic fashion)). The registration can include the user 200 providing basic information (e.g., name, age, date of birth), contact information (e.g., phone number, email address, home address), and payment information (e.g., credit card number). The server 110 does not need to store confidential user information as long as the server 110 has access to the information, which can remain stored securely at another location. Confidential information such as credit card numbers can also be de-identified (i.e. made anonymous) and/or encrypted.

The server 110 can receive data about the actual outcomes from a third-party provider 120 as illustrated in FIG. 3. This data can include the outcomes of events in real-time. These results can be obtained by the server 110 that is then able to support the users that are making predictions on the events. The server 110 can communicate with the third-party provider 120 through the PDN 109 as illustrated in FIG. 3. Additionally or alternatively, the third-party provider 120 can communicate directly with the server 110.

The processing of the methodology can occur at the server 110, the user device 20, or both.

One method of predicting a series of real-time events is during a sporting event. A variety of different sports are applicable, such as but not limited to football, baseball, basketball, and tennis. A user interface accessed on a user device 20 can include various sports that are available at the time for play. For the different sports, the various options are then displayed for the user to select.

In one example, the user can select the “Tennis” which includes a number of different options that are displayed, including “Next Point” and “Radar Gun”. Once the user selects the desired option, a user interface of real-time tennis matches that have associated contests is displayed. A selection of one of the matches is made by user through the user interface. In response, the available contests are displayed that the user can select. For each contest, the user interface can include the number of entries, the entry fee, a time period for each contest (e.g., one game, two games), and a prize.

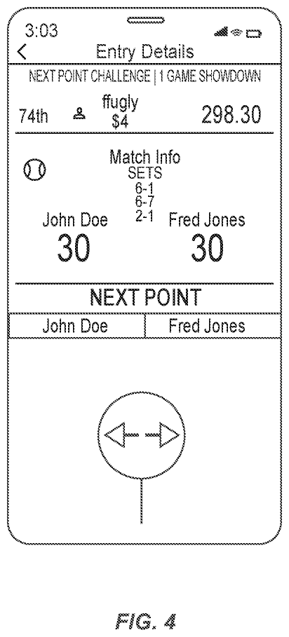

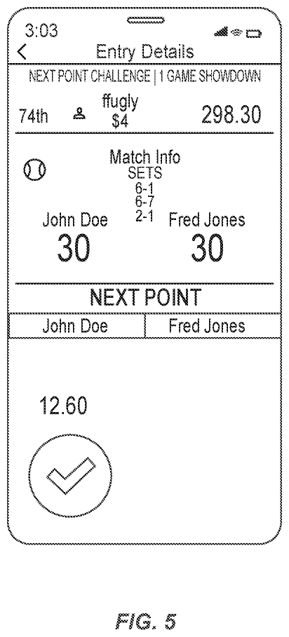

In one example, the series of real-time events are points during one or more games of a tennis match. The user interface as illustrated in FIG. 4 is displayed during the time window leading up to the actual point being won by one of the players in the tennis match. During the time window, the user is prompted to enter their prediction of the outcome. In this embodiment, the user can choose either tennis player to win the next point. During the time window, the user makes their prediction. The time window closes when the point is awarded to one of the players, and the actual outcome is determined. In one embodiment, the actual outcome is supplied by the third-party provider 120. The accuracy of the user prediction is then compared to the actual outcome. The user is then notified of the results. As illustrated in FIG. 5, the user is notified of a successful selection and an award of points.

The process repeats for subsequent real-time events that occur during the tennis match. The next real-time event can be the next point, or can be some point later in the match. For each real-time event, the user makes a prediction during the time window before the outcome occurs. The actual outcome is then determined and the accuracy of the user prediction is determined and the user is notified.

As illustrated in FIGS. 4 and 5, the user can accumulate an overall score based on the outcome of the previous real-time events. The overall score is increased or decreased for each real-time event depending upon the accuracy of the user prediction. The user interface can also include the position of the user to other users. In the embodiment of FIGS. 4 and 5, the user is in 74^{th} position. This position can be based on the overall score, or some other predetermined criteria. The user interface can also include an amount of money that the user would win if they maintain their position in the game (e.g., $4).

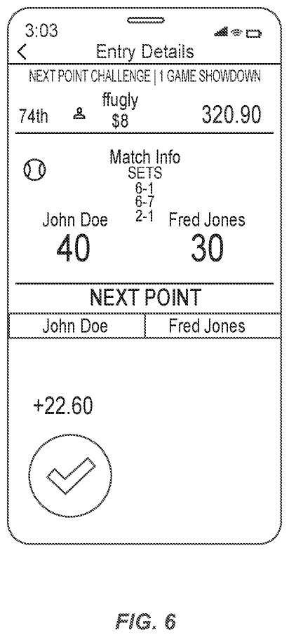

Points can be awarded to the user in a variety of different manners. One design includes each real-time event having a binary outcome, such as which of the two players wins the next point. Other designs can account for the speed in which the user makes their prediction. This can include awarding additional points to a user that makes a fast decision that occurs well before the outcome of the real-time event. FIG. 6 includes an embodiment in which the user prediction was correct and was made in an expedited manner. This results in additional points being awarded to the user.

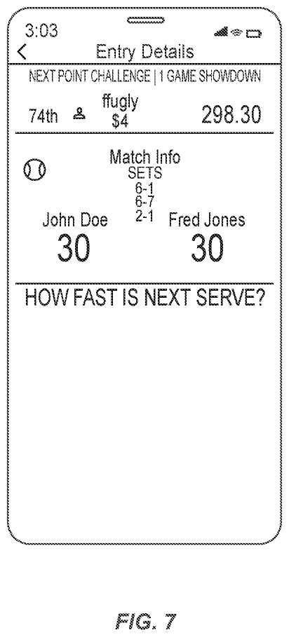

Another example is a Radar Gun game available using the real-time event prediction methodology. This game is selected from a user interface resulting in the display of tennis matches that are occurring in real-time and eligible for play. The user interface than displays available games from the selected tennis match. The different games each include a number of entries, entry fee, duration, and award. As illustrated in FIG. 7, during each real-time event, the user interface displays a query of the speed of the next serve. The user is able to input there prediction. This can include the user inputting a specific speed, or the user interface can include a number of speed ranges from which the user selects one. The user prediction occurs prior to the serve, and then the actual serve speed is determined. The difference between the user prediction and the actual outcome is determined and the user is notified of their result. As in the earlier game, the user interface can include a current cumulative total for the user, the amount of expected winnings for the user, and the user position in the overall user standings.

Another example of predicting a series of real-time events includes selecting a series of pitches in a baseball game. The user selects an outcome prior to each pitch and the actual outcome is then determined. An accuracy of the user prediction is determined and the user is notified. Examples include Strikezone, H/W/O, and Radar Gun). Each of the games occurs during a single sporting event (e.g., Cary Fire v. Apex Rockets baseball game). The user interface includes duration of the game, number of entries, entry fee, and award.

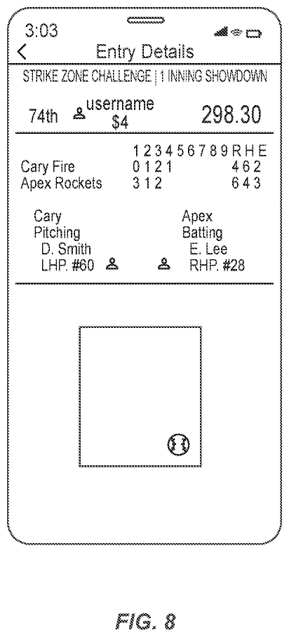

FIG. 8 illustrates a user interface with the Strikezone option. The user interface provides for the user to select where the next pitch will be thrown. The selection options for the user can include a number of discrete positions. The selection options can also include as illustrated in FIG. 8 an open box that provides for the user to select their own position where they believe the next pitch will be located. The user interface can include a box indicating a strike zone and the user can select a position relative to the box. The user prediction is made prior to the event occurring in real-time.

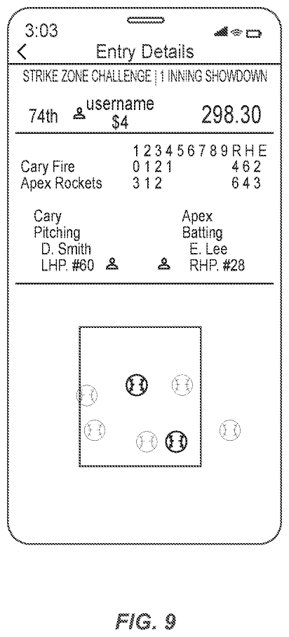

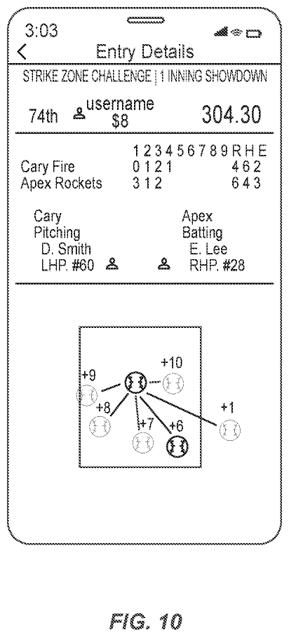

As illustrated in FIG. 9, the user interface can display the user location, and can also include the predictions of the other users of the game. In addition, after the pitch occurs, the user interface can display the actual location of the pitch. FIG. 10 illustrates the user interface displaying the points award to each user prediction. The closer the user prediction is to the actual location, the more points that are awarded to the user. The user's score can be updated to include the results of the latest pitch.

After the pitch, the user interface again displays a clear strike zone for the user to select the location of the next pitch. The user makes their next selection which is then displayed on the user interface. The method continues for the selected duration. At the end of the duration, one or more awards can be given to the user or users with the highest scores.

In the methodologies described above, the user interface displays the same user prediction options prior to each real-time event. The user is then able to make their selection.

The user interface can be configured to provide a variety of options for the user to input their selection of the outcome of the real-time event. In one example, the user interface includes a baseball strike zone in which the user inputs their prediction for the expected location of a pitch. After making the selection, the selections of other users are also displayed. Once the pitch is thrown, the actual location of the pitch is displayed on the user interface. This provides for the user to visually compare their selection with the others.

In one example, the score for each user is calculated as:

Score=1/(actual pitch location−user prediction) (Eq. 1)

In a more specific example, the score determined by Equation 1 is further refined by multiplying the denominator by a score variable.

In another example, the user interface includes a box for the location of the pitch. An outer section of the box is designated for a ball. A central area includes a smaller box indicating the strike zone. This smaller box is further divided into smaller sections indicating different areas of the strike zone, including inner and outer strike zone areas. Prior to the pitch, the user selects one of the displayed areas. The user prediction can be displayed on the user interface, as well as the actual location. The score for the user is determined based on an accuracy of the user prediction relative to the actual pitch location.

In another example, the user interface provides for the user to input either that a pitch will be a ball or a strike. The user makes a selection which is then displayed on the user interface. After the pitch, the actual position of the pitch (either a ball or a strike) can also be displayed.

Another example includes the user guessing the speed of a baseball pitch. The user interface can include a slide bar that the user slides to adjust the selected pitch speed. Once positioned at the proper guess, the user inputs the selection. The user prediction can be displayed on the user interface. Further, the actual speed of the pitch can be displayed after the pitch is thrown. In a similar example, the user interface includes a number of predetermined pitch speed ranges. The user prediction can be indicated on the user interface. Further, the actual pitch speed can be displayed after the pitch is thrown.

Another example includes a user interface in which the user selects the result of a particular batter. In one design, the user options include a hit, walk, or an out. The user prediction can be displayed. The actual result can then be displayed after the play in completed.

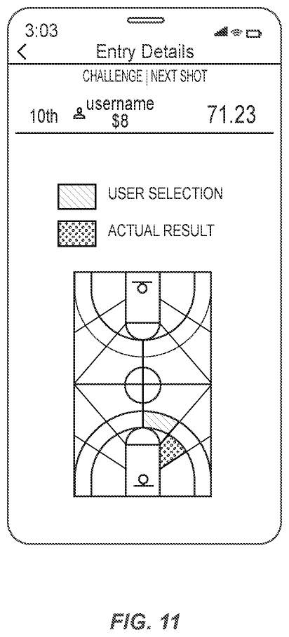

Other sports games are also applicable for predicting outcomes. FIG. 11 includes a user interface for selecting real-time events in a basketball game. The user interface includes different areas on a basketball court from which the user believes the next shot will be taken. Once the user inputs their prediction, the area can be highlighted. After the next shot is actually taken, the corresponding area of the actual result can be highlighted.

Another example is for selecting real-time events in a soccer game. The user interface includes different areas of a soccer field from which the next shot on goal will be taken. Once the user inputs their selection, the area can be highlighted. After the next shot is actually taken, the corresponding area can be highlighted.

Football is another game for predicting outcomes. In one example, the user interface provides for selecting whether a play will be a run or a pass. The user prediction can be highlighted on the user interface. After the play occurs, the actual type of play can be highlighted. In another example, the user interface provides for selecting how many yards from scrimmage will be gained during a play. The user can slide an input bar to input their prediction. The user prediction can be shown on the user interface. After the play is completed, the actual yards from scrimmage can be displayed on the user interface. Another example provides for selecting whether a play will gain yards from the line of scrimmage. The user can input whether the play will or will not gain yardage. The user prediction can be shown on the user interface. After the play is completed, the actual yards from scrimmage can be displayed on the user interface.

The various methods include the user making a series of predictions on discrete, repeatable events. The events can occur multiple times during a larger event. For example, a discrete play within a game. For each event, the user inputs a prediction from the same options. The number of events that can make up the total method can vary from a limited number that occur over a relatively short time period, to a larger number that occur over an extended period of time. Further, the events can occur in immediately after each other (e.g., each pitch of a baseball game), or can occur in different timing sequences (e.g., each third pitch of a baseball game, each first down play of a football game).

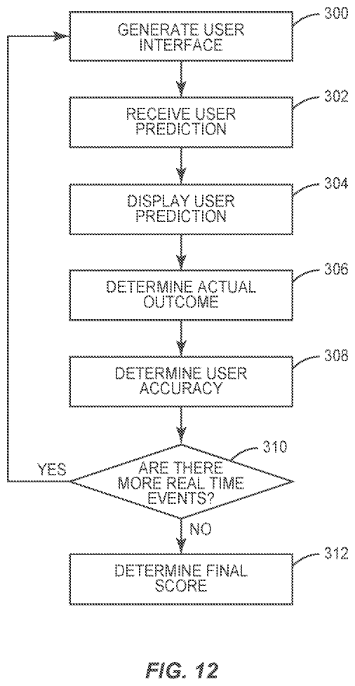

FIG. 12 discloses a method of enabling a user to predict a series of real-time events. The method includes generating a user interface (block 300). The user interface can include options for the user to make a prediction on the outcome of a real-time event. A user prediction is received prior to the occurrence of the real-time event (block 302). The prediction can be made during a time window that occurs before the occurrence of the real-time event. The user prediction can be displayed on the user interface (block 304). This can allow the user to track their prediction while following the real-time event.

Once the real-time event occurs, the outcome is determined (block 306). The outcome can be displayed on the user interface to allow the user to visually see their prediction relative to the outcome.

After the occurrence of the event, an accuracy of the user prediction is determined (block 308). This can include determining a difference between the user prediction and the actual outcome. The accuracy can be a binary outcome (e.g., yes or no) or can be scored in degrees (e.g., distance away from a predicted location).

The method can determine whether there are additional real-time events (block 310). If there are, the process repeats with the user interface providing for the subsequent user prediction. If there are not more real-time events, a final score can be determined (block 312). The final score can be an accumulating score that is maintained during the method. Additionally or alternatively, the final score can be calculated at the end of the real-time events.

During the methodology, the user interface provides for the user to make their prediction prior to the occurrence of the event. Further, the actual outcome is determined and an accuracy can be determined prior to the next real-time event. In this manner, the user is able to know an accumulating score for the overall method.

The actual results of the real-time events can be obtained in a variety of different manners. This can include receiving the results from a third party provider. This can also include a person being located at or otherwise watching the event. The person is able to input the result in real-time to allow the methodology to perform the necessary scoring and displaying.

Terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

Those skilled in the art will appreciate that the various methods and processes described herein may be implemented using various hardware configurations that generally, but not necessarily, include the use of one or more microprocessors, microcontrollers, digital signal processors, or the like, coupled to memory storing software instructions or data for carrying out the techniques described herein. In particular, those skilled in the art will appreciate that the circuits of various embodiments may be configured in ways that vary in certain details from the broad descriptions given above. For instance, one or more of the processing functionalities discussed above may be implemented using dedicated hardware, rather than a microprocessor configured with program instructions. Such variations, and the engineering tradeoffs associated with each, will be readily appreciated by the skilled practitioner. Since the design and cost tradeoffs for the various hardware approaches, which may depend on system-level requirements that are outside the scope of the present disclosure, are well known to those of ordinary skill in the art, further details of specific hardware implementations are not provided herein.

Embodiments of the present disclosure may additionally or alternatively include one or more aspects of the embodiments enumerated below, and/or any compatible combination of features described herein. The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein. Although steps of various processes or methods described herein may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention.

What is claimed is:

1. A method, implemented by an electronic device, the method comprising:
generating a user interface configured to enable a user to predict, for a plurality of sequentially-occurring real-time events during a respective time window, an outcome of the real-time event from a plurality of available outcomes;
receiving via the user interface, during each of the time windows and prior to the corresponding real-time event, a user prediction indicating at least one of the outcomes;
responsive to each of the real-time events occurring, determining an actual outcome of the real-time event; and
notifying the user of an accuracy of the corresponding user prediction based on the actual outcome.

2. The method of claim 1, wherein generating the user interface comprises outputting the user interface on a display device.

3. The method of claim 1, wherein generating the user interface comprises sending a definition of the user interface to a remote computing device for display on a display device.

4. The method of claim 1, further comprising generating the user interface in response to receiving a request from the user to predict the plurality of real-time events.

5. The method of claim 1, wherein determining the actual outcome of the real-time event comprises receiving the actual outcome from the third party prior to the occurrence of the next one of the real-time events.

6. The method of claim 1, further comprising calculating a numerical value score for the real-time event based on a difference between the user prediction and the actual outcome of the real-time event after each occurrence of one of the plurality of real-time events.

7. The method of claim 1, wherein the electronic device is a server that communicates with a computing device via a packet data network.

8. The method of claim 1, wherein the method is implemented at a user computing device.

9. The method of claim 1, wherein the series of real-time events comprises plays in a game.

10. The method of claim 1, further comprising displaying scores of one or more additional users that are also predicting the series of real time events.

11. A method implemented by a first computing device that communicates with a second computing device via a packet data network of enabling a user to predict a series of real-time events, the method comprising:
receiving a request from a second computing device to predict a plurality of sequentially-occurring real-time events that occur over a predetermined period and that have a plurality of available outcomes;
prior to each real-time event:
transmitting via the packet data network to the second computing device a user interface configured to enable a user to predict the real-time event by selecting one of the plurality of available outcomes;
receiving the selected outcome from the second computing device via the packet data network;
after each real-time event and prior to a subsequent one of the plurality of real-time events:
determining an actual outcome of the real-time event;
calculating a numerical value score for the real-time event based on a difference between the selected outcome and the actual outcome; and
calculating a score for the user.

12. The method of claim 11, wherein determining the actual outcome of the real-time event comprises receiving the actual outcome from a remote third party through the packet data network.

13. The method of claim 12, further comprising receiving the actual outcome from the third party prior to the occurrence of the next one of the real-time events.

14. The method of claim 11, further comprising the user interface having a discrete number of the available outcomes.

15. The method of claim 11, further comprising:
receiving via the packet data network selected outcomes of the real-time event from a plurality of additional users; and
after the real-time event and prior to a subsequent one of the real-time events, calculating a numerical value score for the real-time event for each of the plurality of additional users based on a difference between the selected outcome of the event and the actual outcome of the event.

16. The method of claim 15, further comprising transmitting via the packet data network to the second computing device a current position of the user relative to the plurality of additional users based on the numerical value scores.

17. The method of claim 11, wherein each of the real-time events comprises a different play during a game.

18. A computer program product stored in a non-transitory computer readable medium for controlling a computing device, the computer program product comprising software instructions that, when run on the computing device, cause the computing device to:
generate a user interface configured to enable a user to predict, for a plurality of sequentially-occurring real-time events during a respective time window, an outcome of the real-time event from a plurality of available outcomes;
receive, during each of the time windows and prior to the corresponding real-time event, a user prediction of at least one of the outcomes;
determine an actual outcome of the real-time event; and
notify the user of an accuracy of the corresponding user prediction based on the actual outcome.
